(19) United States
(12) Patent Application Publication
(10) Pub. No.: US 2018/0260447 A1
(43) Pub. Date: Sep. 13, 2018

(54) ADVANCED ANOMALY CORRELATION PATTERN RECOGNITION SYSTEM

(71) Applicant: International Business Machines Corporation, Armonk, NY (US)

(72) Inventors: Meagan L. Bergman, Twinsburg, OH (US); Al Chakra, Apex, NC (US); Ernest A. Petrilli, Cleveland, OH (US); Ivan Radas, Highland Heights, OH (US)

(21) Appl. No.: 15/453,549

(22) Filed: Mar. 8, 2017

(51) Int. Cl. G06F 17/30; G06F 17/27

(52) U.S. Cl. CPC G06F 17/30528; G06F 17/30864; G06F 17/30554; G06F 17/2705

(57) ABSTRACT

An anomaly identification data system is provided which identifies anomalies from a data pool. The system receives a queried input condition, extracts one or more standard attributes corresponding to the queried input condition from an initial data pool, and determines a standard correlation between the standard attribute and the queried input condition. The system identifies at least one missing input condition excluded from the at least one standard correlation as an anomalous attribute, and generates an anomalous data pool based on the anomalous attribute. The system further determines at least one initial anomalous correlation between the anomalous attribute included in the anomalous data pool and the at least one queried input condition.

### BACKGROUND

The present application relates generally to data processing systems, and more particularly, to pattern recognition systems.

Conventional pattern recognition systems to date are limited to identifying elements included in given data pool which match known elements stored in the data system's memory or fit a known model stored by the pattern recognition system. For instance, a conventional pattern recognition system typically stores one or more natural language algorithms that are configured to extract targeted data elements from a large input data set. The pattern recognition system may then perform additional analytics on the extracted data elements according to an input condition. The input condition is typically a user query or known correlation input by a user. Thus, the pattern recognition system and the user are aware of the target condition that is to be identified among the extracted data elements. However, data elements that are not first provided to the pattern recognition system cannot be identified, and thus cannot be further analyzed.

### SUMMARY

According to a non-limiting embodiment, an anomaly identification data system is provided which identifies anomalies from a data pool. The system receives a queried input condition, extracts one or more standard attributes corresponding to the queried input condition from an initial data pool, and determines a standard correlation between the standard attribute and the queried input condition. The system identifies at least one missing input condition excluded from the at least one standard correlation as an anomalous attribute, and generates an anomalous data pool based on the anomalous attribute. The system further determines at least one initial anomalous correlation between the anomalous attribute included in the anomalous data pool and the at least one queried input condition.

According to another non-limiting embodiment, a method of identifying anomalies from a standard data pool comprises extracting at least one standard attribute, corresponding to at least one queried input condition, from the standard data pool, and determining at least one standard correlation between the at least one standard attribute and the at least one queried input condition. The method further includes identifying at least one missing input condition excluded from the at least one standard correlation as an anomalous attribute, and generating an anomalous data pool based on the anomalous attribute. The method further includes determining at least one initial anomalous correlation between the anomalous attribute included in the anomalous data pool and the at least one queried input condition.

According to yet another non-limiting embodiment, a computer program product identifies anomalies from a standard data pool. The computer program product comprises a computer readable storage medium having program instructions embodied therewith. The program instructions are executable by a processing circuit to cause the processing circuit to extract at least one standard attribute, corresponding to at least one queried input condition, from the standard data pool, and determine at least one standard correlation between the at least one standard attribute and the at least one queried input condition. The program instructions further control the processing circuit to identify at least one missing input condition excluded from the at least one standard correlation as an anomalous attribute, and generate an anomalous data pool based on the anomalous attribute. The program instructions further control the processing circuit to determine at least one initial anomalous correlation between the anomalous attribute included in the anomalous data pool and the at least one queried input condition.

### BRIEF DESCRIPTION OF THE DRAWINGS

The examples described throughout the present document will be better understood with reference to the following drawings and description. The components in the figures are not necessarily to scale. Moreover, in the figures, like-referenced numerals designate corresponding parts throughout the different views.

FIG. 1 depicts a cloud computing environment according to one or more embodiments;

FIG. 2 illustrates a set of functional abstraction layers provided by a cloud computing environment according to one or more embodiments;

FIG. 3A is a block diagram of an anomaly identification data system according to a non-limiting embodiment;

FIG. 3B is a block diagram illustrating a cascading model having a correlating aspect with respect to the anomalous results generated by the anomaly identification data system of FIG. 3A according to a non-limiting embodiment;

FIG. 4 illustrates an example computer system that implements technical features described herein according to one or more embodiments; and

FIG. 5 is a flow diagram illustrating a method of correlating previously unknown anomalies in conjunction with a pattern recognition process according to a non-limiting embodiment.

### DETAILED DESCRIPTION

Various non-limiting embodiments described herein provide an anomaly identification data system capable of extracting data elements from a data set corresponding to an input condition, identifying anomalies among the data set that do not fit a known model, and correlating these anomalies with previously unknown attributes of the input condition. In addition, the anomaly identification data system can generate a cascading model having a correlating aspect with respect to the anomalous results. A closed-loop exists that returns the anomalous results to the system's mainframe computer system to feedback unknown attributes which did not follow the modeled pattern of the mainframe computer system's analytics logic. Accordingly, the anomaly identification data system is capable of improving research and development tasks while also streamlining analytics conducted by industries or technical fields responsible for performing analytics on extremely large data pools.

In at least one non-limiting embodiment, the anomaly identification data system can execute natural language processes to generate a data pool associated with an input criteria, i.e., query. For example, a diabetes query can return a data pool including medical records for all diabetes patients recorded in one or more accessible databases. Once queried, the anomaly identification data system can execute several analytical operations. Analytical operations can include, for example, performing a common attribute search among the obtained data pool (e.g., data records), and comparing the results to a standard or known listing of attributes commonly associated with the searched condition. Correlations excluded from the standard list are flagged as anomalies (i.e., anomalous data) which can be displayed in a dashboard or graphic user interface (GUI) for further human and/or autonomous machine analysis.

The anomalous data can also be compared to the initial data pool, in conjunction with the given queried criteria. If there are any further data correlation discrepancies between the queried criteria and the data pool of a specified threshold (e.g., a threshold value or percentage), the results can be further grouped together and displayed via the GUI to enable more specific data analysis and improved data reporting. In this manner, the anomaly identification data system can benefit the research and development community by executing a unique combination of operations that solve the existing problem of overlooking anomalies in a data pool, and determining correlations between these overlooked anomalies and a queried data condition which cannot be achieved by conventional pattern recognition systems.

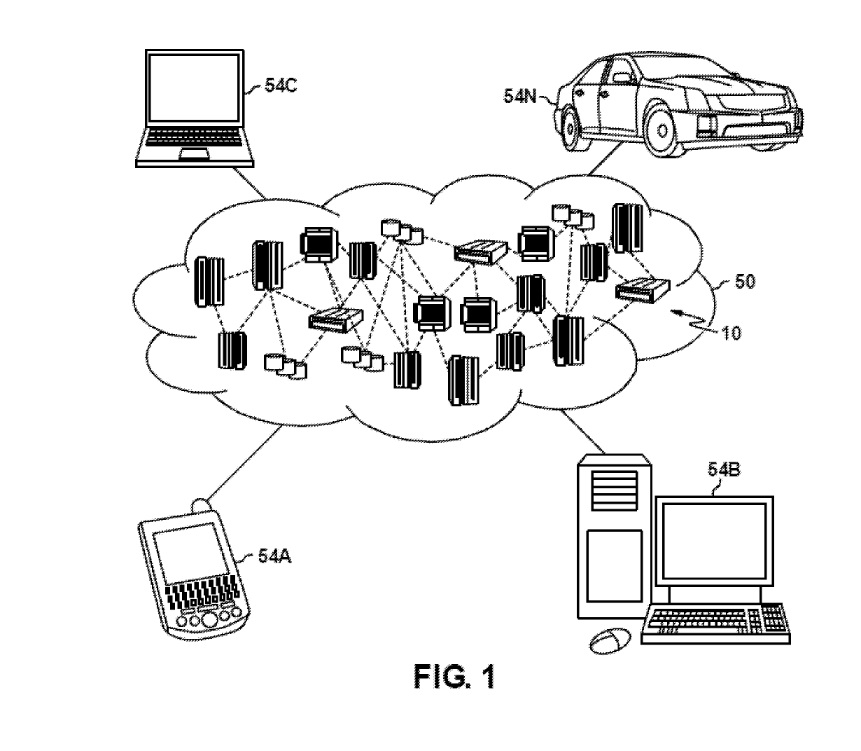

Turning now to FIG. 1, a cloud computing environment is illustrated according to one or more embodiments. It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-54N shown in FIG. 1 are intended to be illustrative only and that computing nodes 10 and cloud computing environment 50 can communicate with any type of computerized device over any type of network and/or network addressable connection (e.g., using a web browser).

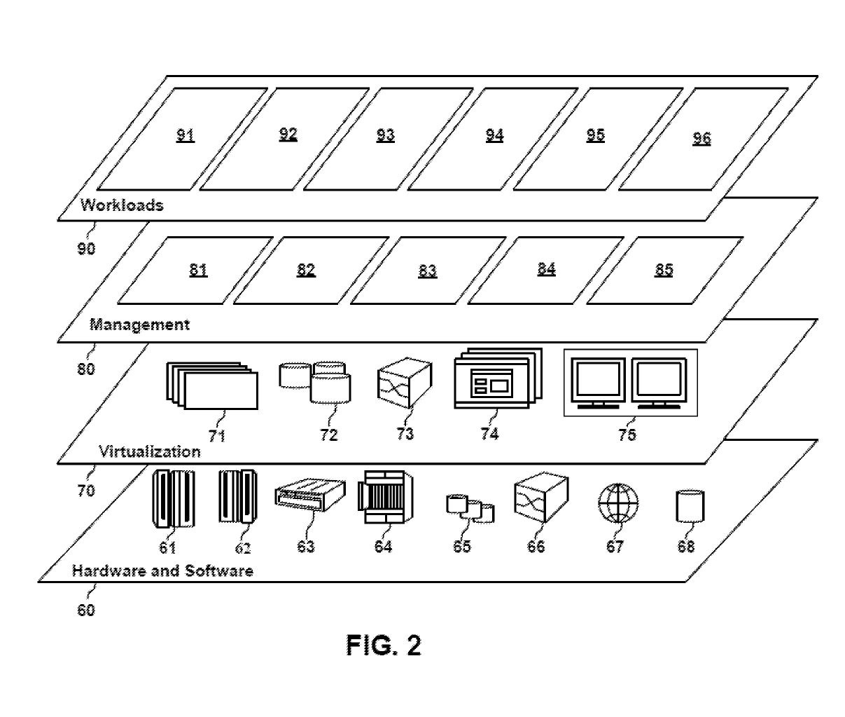

Referring now to FIG. 2, a set of functional abstraction layers provided by cloud computing environment 50 (see FIG. 1) is shown. It should be understood in advance that the components, layers and functions shown in FIG. 2 are intended to be illustrative only and embodiments of the invention are not limited thereto. As depicted, the following layers and corresponding functions are provided:

Hardware and software layer 60 include hardware and software components. Examples of hardware components include mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and streaming data for analytics 96.

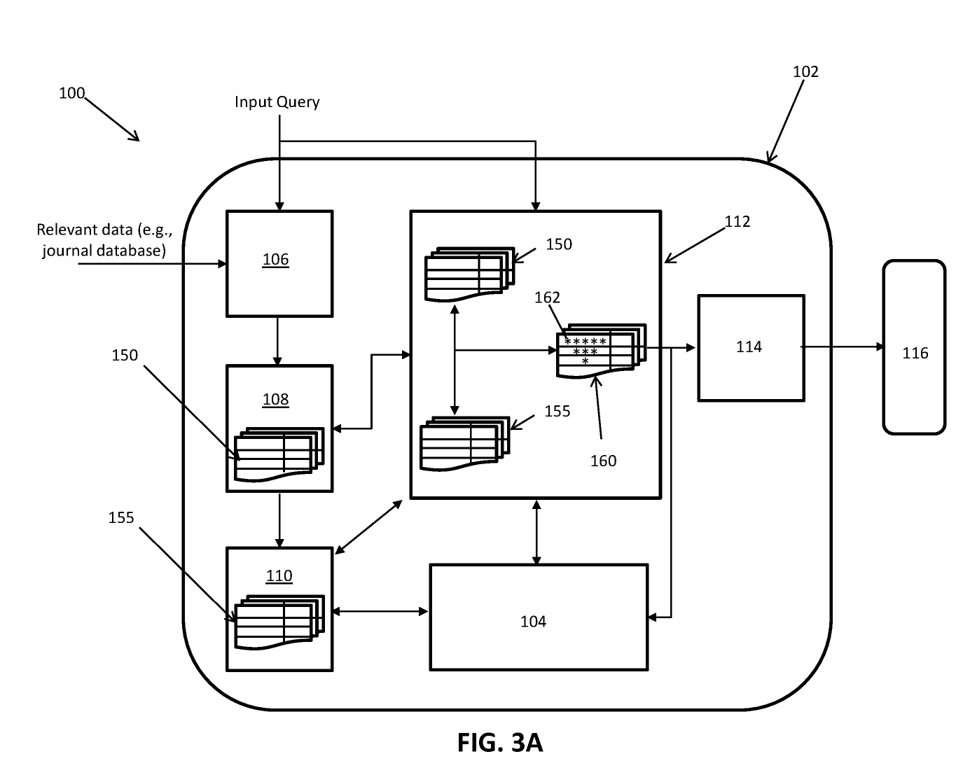

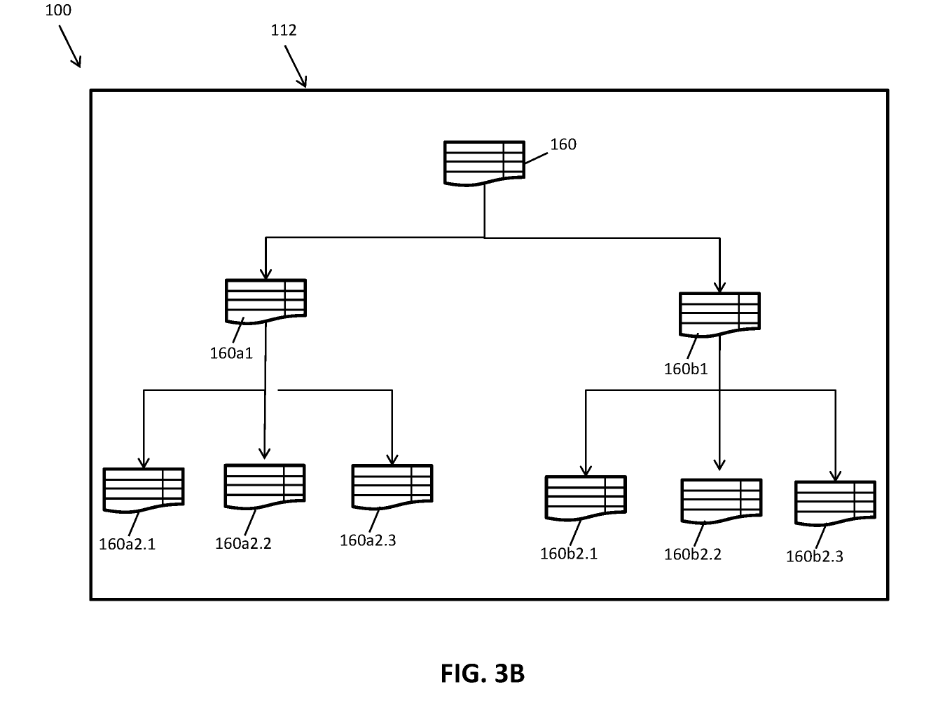

Referring now to FIG. 3A an example system 100 is illustrated which implements the technical features described herein according to a non-limiting embodiment. The system 100 can operate as an anomaly identification data system 100 including a mainframe computer system 102, a memory unit, 104, and one or more analytical modules 106-114. The mainframe computer system 102 and any of the analytical modules 106-114 can be constructed as an electronic hardware controller that includes memory (e.g., 104) and a processor configured to execute algorithms and computer-readable program instructions stored in the memory 104.

In one or more examples, the mainframe computer system 102 is a server computer, such as an IBM™ Z-SYSTEM™ or the like. Alternatively, or in addition, the mainframe computer system 102 may be a server cluster, which includes one or more server computers. For example, the mainframe computer system 102 may be a distributed computing server. It should be noted that the mainframe computer system 102 is not limited to the number of analytical modules 106-114 illustrated in FIG. 3A. For instance, more or less modules can be employed to perform the operations of the mainframe computer 102. The analytical modules 106-114 an information retriever (IR) module 106, a natural language module 108, a known correlation generator module 110, an anomaly identification (ID) module 112, and a dashboard module 114.

The memory unit 104 can have a data storage capacity ranging from 10 terabytes to 10 petabytes, for example, and is configured to store various algorithms, analytics logic programs, and other data content including technical papers, medical journals, patient medical records, genome data (e.g., Deoxyribonucleic acid (DNA) sequences), treatment success/fail rates, legal publications, research documents, encyclopedia data, mathematical formulas, etc. One or more of the modules 106-114 included in the mainframe computer system 102 can read and/or write to the memory module 104.

The IR module 106 can obtain an immense amount of structured and/or unstructured content (e.g., hundreds of millions of pages) from the memory module 104. In addition, the IR module 106 can be connected to the Internet and obtain additional data from remotely located data sources (e.g., data servers located remotely from the mainframe computer system 102).

In at least one embodiment, the IR module 106 receives an input condition (e.g., a query) provided by a user. In terms of the medical field, for example, the query can include a particular disease (e.g., lung cancer, heart disease, etc.), or one or more symptoms (loss of appetite, shortness of breath, chest pain, fever, existing rash, etc.) Based on the query, the IR module 106 accesses the content obtained from the memory unit 104 and/or one or more external data sources to generate a data pool that includes data to the query.

The natural language module 108 executes various algorithms to extract data from the data pool generated by the IR module 106. The algorithms include, but are not limited to, natural language recognition logic, pattern recognition algorithms, hypothesis generation algorithms, predictive annotation modeling, evidence-based learning algorithms, and language filters.

Using the various algorithms described above, the natural language module 108 can extract one or more attributes that correspond to the query. When the query is “lung cancer,” for example, the natural language module 108 can generate an attribute table 150 that lists one or more attributes that correspond to the query (e.g., lung cancer). For example, performing the various natural language algorithms on a given data pool including hundreds of thousands of medical journals, research papers, and patient records may result in the extraction of excerpts discussing cigarette smoke, asbestos, radon gas, etc., along with current patients suffering from lung cancer. Accordingly, the natural language module 108 can generate an attribute table 150 that lists all attributes (causes, patients, etc.) extracted from the data pool generated in response to the query. The attributes listed in the attribute table 150 are referred to as “known attributes,” because they appear in the excerpts extracted from the data pool. In at least one embodiment, the natural language module 108 can also apply a numerical indicator to each attribute listed in the attribute table 150. The indicator conveys the number of times a particular attribute was identified from within the data pool.

The known correlation generator module 110 receives the attribute table 150, and determines various correlations between the query and the attributes listed in the attribute table 150. In at least one embodiment, the known correlation generator module 110 determines that an attribute is directly related to the subject of the query when the numerical indicator exceeds a threshold value. For instance, the known correlation generator module 110 can determine a “cause correlation” between lung cancer (e.g., the query) and cigarette smoke (e.g., the attribute) because the numerical indicator (i.e., the number of times the term “cigarette smoke” was identified from the data pool) assigned to the term “cigarette smoke” exceeded a threshold value. In another example, the known correlation generator module 110 can determine a “symptom correlation” between chest pain (e.g., the query) and heart disease (e.g., the attribute) because the numerical indicator assigned to the term “heart disease” exceeded a threshold value.

The correlation determined by the known correlation generator module 110 is referred to as a known correlation or standard correlation because the correlation was based on attributes appearing in excerpts of medical journals and research literature. Based on the known correlations, the known correlation generator module 110 can generate a known correlation table 155. The known correlation table 155 lists all correlations between a given query and various attributes extracted from the data pool. In this manner, the known correlation table 155 can be used as a reference to determine one currently unknown or unexpected attributes associated with the query. These currently unknown or unexpected attributes are referred to herein as anomalies or anomalous data.

The anomaly ID module 112 communicates with the natural language module 108 to obtain the attribute table 150, and the known correlation generator module 110 to obtain the known correlation table 155. In at least one embodiment, the anomaly ID module 112 compares the input query data to the correlations listed in the known correlation table 155. The anomaly ID module 112 determines that an anomaly exists when data included in the query is excluded from the known correlation table 155.

For example, a user input query for a rare type of cancer generates a known correlation table 155 that lists several different correlations to the rare cancer query. However, 10 patients included in the attribute table 150 are also diagnosed with the rare cancer, but are not associated with any of the correlations listed in the known correlation table 155. Accordingly, the anomaly ID module 112 flags the 10 patients as anomalies (i.e., anomalous data) and generates an anomaly table 160 listing the anomalous data (e.g., the 10 anomalous patients), along with one or more attributes corresponding to the anomalous data. In terms of the 10 patients, for example, the attributes can include, but are not limited to, gender, family history, genetic information, residential information, employment information, etc.). In at least one embodiment, the anomalous correlations are ranked. For example, a count indicator 162 can be applied to each correlation associated with a particular anomalous attribute. Anomalous correlations having higher count indicators 162 than the remaining anomalous correlations can indicate that the anomalous attribute associated with the higher count indicator 162 has a higher relevancy than the remaining anomalous attributes.

The anomaly ID module 112 delivers the anomaly table 160 to the dashboard module 114, which in turn generates graphics data representing the anomaly table 160. The graphics data can be output to a GUI 116 which in turn displays a graphical representation of the anomaly table 160. Accordingly, a user is alerted of anomalies related to the input search query, and can perform further analytics to determine one or more correlations among the anomalous data.

Referring to FIG. 3B, for example, the anomaly ID module 112 is configured to create sub-groups 160a1 and 160b1, 160a2.1-160a2.3 and 160b2.1-160b2.3, etc. (i.e., sub-correlations stemming from higher-level correlations) on the analytics of the anomalous data table 160. For example, the mainframe computer 102 may receive a cascade data request input by the user, which indicates that the user requests further analysis of the anomalous data table 160 to obtain more granular results. In response to receiving the cascade data request, the ID module 112 can create cascading ring-like sub-groups 160a1 and 160b1, 160a2.1-160a2.3 and 160b2.1-160b2.3, etc. originating from the initial anomalous data table 160. These cascading sub-groups 160a1 and 160b1, 160a2.1-160a2.3 and 160b2.1-160b2.3, etc. originate from the first/original level of the anomalous data table 160, and then the anomaly identification data system 100 creates cascading sub-groups 160a1 and 160b1, 160a2.1-160a2.3 and 160b2.1-160b2.3, etc. motivated by subsequent identified anomalies existing in the original anomalous data level 160. These cascading sub-groups 160a1 and 160b1, 160a2.1-160a2.3 and 160b2.1-160b2.3, etc. can then be correlated by common attributes amongst the data elements of the previous sub-group level (e.g., 160n-1). In another embodiment, the cascading data request can be automatically initiated when the abnormal correlation results exceed a threshold value or parentage.

With reference to the rare cancer example described above, the anomalous data can be fedback into the mainframe computer 102 such that additional analytics can be performed. For example, the known correlation generator module 110 may determine that each of the 10 anomalous patients resided in close proximity to one another. Accordingly, the known correlation generator module 110 determines that a new sub-correlation (i.e., residential location) exists between the current input query (e.g., the rare cancer) and the anomalous data (e.g., the 10 anomalous patients). In this manner, it can be discerned that the 10 anomalous patients may be commonly exposed to an environmental element that contributes to the development of the rare cancer.

As described above, the anomalous ID module 112 not only analyzes currently known correlations to identify previous unexpected anomalies existing between the data pool and an input query, but also identifies sub-correlations 160a1 and 160b1, 160a2.1-160a2.3 and 160b2.1-160b2.3, etc. of the identified anomalies. The sub-correlations 160a1 and 160b1, 160a2.1-160a2.3 and 160b2.1-160b2.3, etc. can be provided to the dashboard module 114, and then displayed via the GUI 116 such that a user can perform granular analytics and determine additional information/details related to their initial query. Multiple sub-correlations among the anomalous data can be identified and listed in the GUI 116 and sorted by a correlation count. In this manner, users are able to investigate and further analyze these detected anomalous correlations and remove one or more sub-correlations from their personal profiles. The anomaly identification data system 100, however, can still store removed correlations and removed anomalous sub-correlations in memory 104 for other users to reference in the back-end.

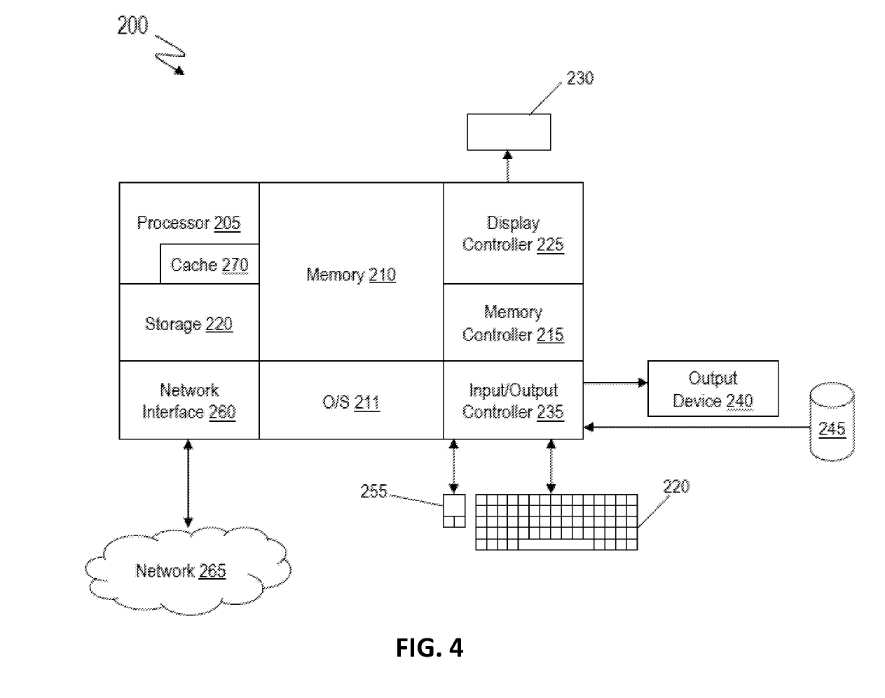

FIG. 4 illustrates an example computer system 200 that can facilitate an anomaly identification data system (see FIGS. 3A-3B) to perform the technical features described herein. The system 200 may operate as the mainframe computer system 102 and/or one of the analytics modules 106-114. It should be noted that the mainframe computer system 102 and/or the analytics modules 106-114 can include additional, or fewer components in other examples, then those illustrated in FIG. 4.

The computer system 200 includes, among other components, a processor 205, memory 210 coupled to a memory controller 215, and one or more input devices 245 and/or output devices 240, such as peripheral or control devices, which are communicatively coupled via a local I/O controller 235. These devices 240 and 245 may include, for example, battery sensors, position sensors (altimeter, accelerometer, GPS), indicator/identification lights and the like. Input devices such as a conventional keyboard 250 and mouse 255 may be coupled to the I/O controller 235. The I/O controller 235 may be, for example, one or more buses or other wired or wireless connections, as are known in the art. The I/O controller 235 may have additional elements, which are omitted for simplicity, such as controllers, buffers (caches), drivers, repeaters, and receivers, to enable communications.

The I/O devices 240, 245 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 205 is a hardware device for executing hardware instructions or software, particularly those stored in memory 210. The processor 205 may be a custom made or commercially available processor, a central processing unit (CPU), an auxiliary processor among several processors associated with the computer system 200, a semiconductor based microprocessor (in the form of a microchip or chip set), a macroprocessor, or other device for executing instructions. The processor 205 includes a cache 270, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 270 may be organized as a hierarchy of more cache levels (L1, L2, and so on.).

The memory 210 may include one or combinations of volatile memory elements (for example, random access memory, RAM, such as DRAM, SRAM, SDRAM) and nonvolatile memory elements (for example, ROM, erasable programmable read only memory (EPROM), electronically erasable programmable read only memory (EEPROM), programmable read only memory (PROM), tape, compact disc read only memory (CD-ROM), disk, diskette, cartridge, cassette or the like). Moreover, the memory 210 may incorporate electronic, magnetic, optical, or other types of storage media. Note that the memory 210 may have a distributed architecture, where various components are situated remote from one another but may be accessed by the processor 205.

The instructions in memory 210 may include one or more separate programs, each of which comprises an ordered listing of executable instructions for implementing logical functions. In the example of FIG. 4, the instructions in the memory 210 include a suitable operating system (OS) 211. The operating system 211 essentially may control the execution of other computer programs and provides scheduling, input-output control, file and data management, memory management, and communication control and related services.

Additional data, including, for example, instructions for the processor 205 or other retrievable information, may be stored in storage 220, which may be a storage device such as a hard disk drive or solid state drive. The stored instructions in memory 210 or in storage 220 may include those enabling the processor to execute one or more aspects of the systems and methods described herein.

The computer system 200 may further include a display controller 225 coupled to a user interface or display 230. In some embodiments, the display 230 may be an LCD screen. In other embodiments, the display 230 may include a plurality of LED status lights. In some embodiments, the computer system 200 may further include a network interface 260 for coupling to a network 265. The network 265 may be an IP-based network for communication between the computer system 200 and an external server, client and the like via a broadband connection. In an embodiment, the network 265 may be a satellite network. The network 265 transmits and receives data between the computer system 200 and external systems. In some embodiments, the network 265 may be a managed IP network administered by a service provider. The network 265 may be implemented in a wireless fashion, for example, using wireless protocols and technologies, such as WiFi, WiMax, satellite, or any other. The network 265 may also be a packet-switched network such as a local area network, wide area network, metropolitan area network, the Internet, or other similar type of network environment. The network 265 may be a fixed wireless network, a wireless local area network (LAN), a wireless wide area network (WAN) a personal area network (PAN), a virtual private network (VPN), intranet or other suitable network system and may include equipment for receiving and transmitting signals.

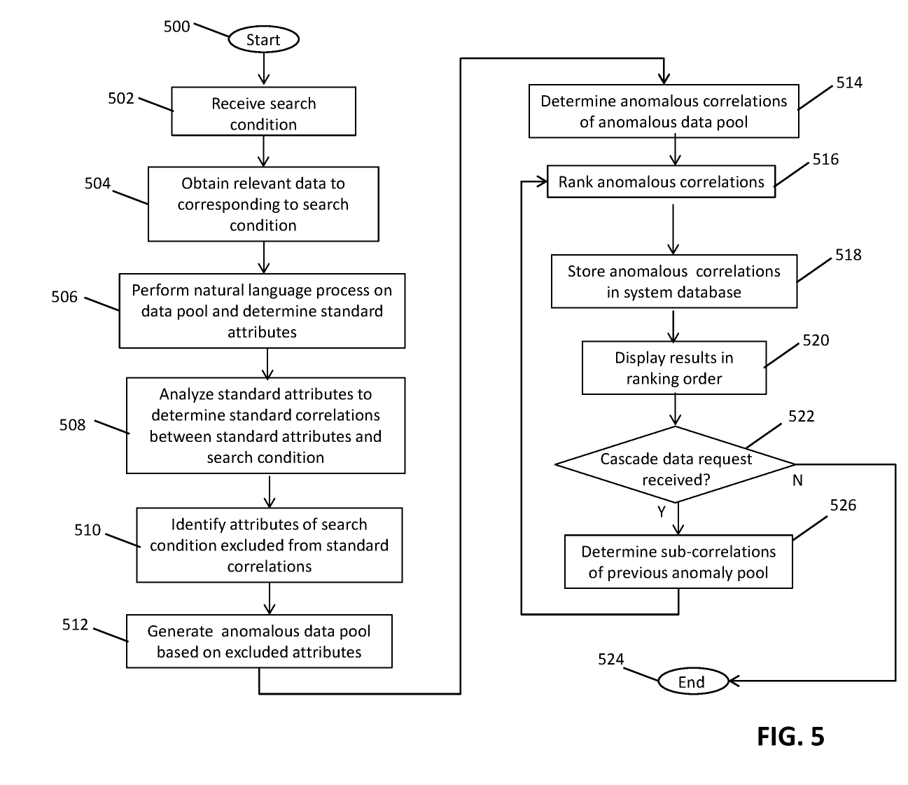

FIG. 5 is a flow diagram illustrating a method of correlating previously unknown anomalies in conjunction with a pattern recognition process according to a non-limiting embodiment. The method begins at operation 500, and at operation 502 a query is received which indicates one or more search conditions. The query includes, for example, a query for a particular disease, medical symptoms, etc. The input condition is not limited to medical applications, and can span a wide range of applications. At operation 504, data relevant to the query is obtained to generate an initial data pool. The data can be obtained from a memory/database unit of a mainframe computer system performing the method and/or one or more external data servers located remotely from the mainframe computer system. At operation 506, the initial data pool is analyzed to identify standard attributes included in the data pool, which correspond to the query. In at least one embodiment, natural language processing can be performed on the initial data pool to identify the attributes. A standard attribute table can be generated in response to the natural language processing which lists the standard attributes identified from the initial data pool. At operation 508, the standard attributes are analyzed to determine standard correlations between the standard attributes and the search conditions submitted via the query. In at least one embodiment, a standard correlation table can be generated which identifies the correlations between the standard attributes and one or more search conditions submitted via the query.

Referring now to operation 510, the standard correlation table is compared to the search conditions to identify whether any attributes of the search condition are excluded from the identified standard correlations (i.e., the standard correlation table). At operation 512, an anomalous data pool is generated based on the excluded attributes. At operation 514, anomalous correlations are determined between one or more search conditions and the anomalous data pool. At operation 516, the anomalous correlations are ranked. For example, a count indicator can be applied to each correlation associated with a particular anomalous attribute. Anomalous correlations having higher count indicators than the remaining anomalous correlations can indicate that the anomalous attribute associated with the higher count indicator has a higher relevancy than the remaining anomalous attributes.

Turning to operation 518, the anomalous correlations are stored in a database for future reference, and the anomalous correlations and rankings are displayed via a GUI at operation 520. At operation 522, a determination is made as to whether a cascade data request is received. When the cascade data request is not received, the method ends at operation 524. When, however, the cascade data request is received additional analytics are performed at operation 526 to determine whether any additional correlations among the previously determined anomalous data pool. The additional analytics include, for example, a sub-group can be generated which is motivated by subsequent identified anomalies existing in the original anomalous data pool. The subsequent anomalous correlations can then be processed as described above (e.g., ranked, stored, displayed, etc.). The cascade request can be repeated several times such that a cascading model is generated in a correlating aspect with respect to the anomalous results. Accordingly, more granular results of the initial anomalous data pool can be generated. When no further cascade requests are received, the method ends at operation 524.

Accordingly, various non-limiting embodiments described herein provide an anomaly identification data system capable of extracting data elements from a data set corresponding to an input condition, identifying anomalies among the data set that do not fit a known model, and correlating these anomalies with previously unknown attributes of the input condition.

The anomalous data can also be compared to the initial data pool, in conjunction with the given queried criteria to generate a cascading model in a correlating aspect with respect to anomalous results generated at an earlier level. If there are any further data correlation discrepancies between the queried criteria and the data pool of a specified threshold (e.g., a threshold value or percentage), the results can be further grouped together to generate a subsequent level of anomalous correlations. The anomalous results (e.g., all anomalous correlation levels) can be displayed via the GUI to enable more specific data analysis and improved data reporting. In this manner, the anomaly identification data system can benefit the research and development community by executing a unique combination of operations that solve the problem of overlooking anomalies in a data pool, and determining correlations between these overlooked anomalies and a queried data condition which cannot be achieved by conventional pattern recognition systems.

The present technical solutions may be a system, a method, and/or a computer program product at any possible technical detail level of integration. The computer program product may include a computer readable storage medium (or media) having computer readable program instructions thereon for causing a processor to carry out aspects of the present technical solutions.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technical solutions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present technical solutions.

Aspects of the present technical solutions are described herein with reference to flowchart illustrations and/or block diagrams of methods, apparatus (systems), and computer program products according to embodiments of the technical solutions. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present technical solutions. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

To clarify the use of and to hereby provide notice to the public, the phrases “at least one of <A>, <B>, . . . and <N>” or “at least one of <A>, <B>, . . . <N>, or combinations thereof” or “<A>, <B>, . . . and/or <N>” are to be construed in the broadest sense, superseding any other implied definitions hereinbefore or hereinafter unless expressly asserted to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed.

As used herein, the term “module” or “unit” refers to an application specific integrated circuit (ASIC), an electronic circuit, a microprocessor, a computer processor (shared, dedicated, or group) and memory that executes one or more software or firmware programs, a combinational logic circuit, a microcontroller including various inputs and outputs, and/or other suitable components that provide the described functionality. The module is configured to execute various algorithms, transforms, and/or logical processes to generate one or more signals of controlling a component or system. When implemented in software, a module can be embodied in memory as a non-transitory machine-readable storage medium readable by a processing circuit (e.g., a microprocessor) and storing instructions for execution by the processing circuit for performing a method. A controller refers to an electronic hardware controller including a storage unit capable of storing algorithms, logic or computer executable instruction, and that contains the circuitry necessary to interpret and execute instructions.

It will also be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Such computer storage media may be part of the device or accessible or connectable thereto. Any application or module herein described may be implemented using computer readable/executable instructions that may be stored or otherwise held by such computer readable media.

The descriptions of the various embodiments of the technical features herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An anomaly identification data system configured to identify anomalies from a data pool, the anomaly identification data system comprising:
a memory; and
an electronic hardware controller in signal communication with the memory, the electronic hardware controller configured to:
extract at least one standard attribute, corresponding to at least one queried input condition, from an initial data pool;
determine at least one standard correlation between the at least one standard attribute and the at least one queried input condition;
identify at least one missing input condition excluded from the at least one standard correlation as an anomalous attribute, and generating an anomalous data pool based on the anomalous attribute; and
determine at least one initial anomalous correlation between the anomalous attribute included in the anomalous data pool and the at least one queried input condition.

2. The anomaly identification data system of claim 1, further comprising a graphic user interface (GUI) in signal communication with the electronic hardware controller, the GUI configured to display a graphical representation of the at least one initial anomalous correlation.

3. The anomaly identification data system of claim 1, wherein the electronic hardware controller determines at least one cascading anomalous sub-group based on the at least one initial anomalous correlation.

4. The anomaly identification data system of claim 3, wherein the cascading anomalous sub-group includes at least one additional anomalous correlation that is excluded from the at least one initial anomalous correlation.

5. The anomaly identification data system of claim 1, wherein the at least one initial anomalous correlation is prioritized according to a number of times the anomalous correlation exists in the anomalous data pool.

6. The anomaly identification data system of claim 1, wherein the at least one anomalous attribute is determined in response to comparing the at least one standard correlation and the at least one queried input condition, and identifying the anomalous attribute as an input condition that is excluded from the at least one standard correlation.

7. The anomaly identification data system of claim 1, wherein the at least one standard attribute is extracted from the standard data pool in response to performing a natural language data processing operation upon the standard data pool.

8. A method of identifying anomalies from a standard data pool, the method comprising:
extracting at least one standard attribute, corresponding to at least one queried input condition, from the standard data pool;
determining at least one standard correlation between the at least one standard attribute and the at least one queried input condition;
identifying at least one missing input condition excluded from the at least one standard correlation as an anomalous attribute;
generating an anomalous data pool based on the anomalous attribute; and
determining at least one initial anomalous correlation between the anomalous attribute included in the anomalous data pool and the at least one queried input condition.

9. The method of claim 8, further comprising displaying a graphical representation of the at least one initial anomalous correlation.

10. The method of claim 8, wherein the at least one cascading anomalous sub-group is determined based on the at least one initial anomalous correlation.

11. The method of claim 10, wherein the cascading anomalous sub-group includes at least one additional anomalous correlation that is excluded from the at least one initial anomalous correlation.

12. The method of claim 8, further comprising prioritizing the initial anomalous correlation according to a number of times the anomalous correlation exists in the anomalous data pool.

13. The method of claim 8, further comprising determining the at least one anomalous attribute in response to comparing the at least one standard correlation and the at least one queried input condition, and identifying the anomalous attribute as an input condition that is excluded from the at least one standard correlation.

14. The method of claim 8, further comprising performing a natural language data processing operation upon the standard data pool to extract the at least one standard attribute.

15. A computer program product for identifying anomalies from a standard data pool, the computer program product comprising a computer readable storage medium having program instructions embodied therewith, the program instructions executable by a processing circuit to cause the processing circuit to:
extract at least one standard attribute, corresponding to at least one queried input condition, from the standard data pool;
determine at least one standard correlation between the at least one standard attribute and the at least one queried input condition;
identify at least one missing input condition excluded from the at least one standard correlation as an anomalous attribute;
generate an anomalous data pool based on the anomalous attribute; and
determine at least one initial anomalous correlation between the anomalous attribute included in the anomalous data pool and the at least one queried input condition.

16. The computer program product of claim 15, further comprising displaying a graphical representation of the at least one initial anomalous correlation.

17. The computer program product of claim 15, wherein the at least one cascading anomalous sub-group is determined based on the at least one initial anomalous correlation.

18. The computer program product of claim 17, wherein the cascading anomalous sub-group includes at least one additional anomalous correlation that is excluded from the at least one initial anomalous correlation.

19. The computer program product of claim 15, further comprising prioritizing the initial anomalous correlation according to a number of times the anomalous correlation exists in the anomalous data pool.

20. The computer program product of claim 15, further comprising determining the at least one anomalous attribute in response to comparing the at least one standard correlation and the at least one queried input condition, and identifying the anomalous attribute as an input condition that is excluded from the at least one standard correlation.
